(19) United States
(12) Patent Application Publication
(10) Pub. No.: US 2017/0291389 A1
(43) Pub. Date: Oct. 12, 2017

(54) Laminate Surface Covering Suited for Marine Environments

(71) Applicant: Kent Weisenberg, Jacksonville, FL (US)

(72) Inventor: Kent Weisenberg, Jacksonville, FL (US)

(21) Appl. No.: 15/482,344

(22) Filed: Apr. 7, 2017

Related U.S. Application Data
(60) Provisional application No. 62/319,551, filed on Apr. 7, 2016.

(51) Int. Cl. B32B 5/18; B32B 5/02; B32B 7/12

(52) U.S. Cl. CPC B32B 5/18; B32B 7/12; B32B 5/028; B32B 2266/08; B32B 2266/02

(57) ABSTRACT

A composite laminate surface covering member in the form of a sheet, panel or mat having an upper layer of bonded, vibration oriented, polymer granules, the upper layer being water permeable and possessing an extensive irregular channeling system formed by the voids between the granules, and a sub-layer of a closed cell polymer that is water impermeable. Additional layers for reinforcing purposes may also be present.

This application claims the benefit of U.S. Provisional Patent Application Ser. No. 62/319,551, filed Apr. 7, 2016, the disclosure of which is incorporated herein by reference.

### BACKGROUND OF THE INVENTION

This invention relates generally to surface coverings for horizontal support surfaces, such as floors, walkways, docks, etc., and for other structural members, such as posts, railings, etc., and in particular such surfaces or members that are exposed to the environment, and even more particularly to such surfaces or members that are in outdoor marine environments.

Many surfaces and structural members are exposed to the environments and thereby subjected to environmental degradation, soiling, the growth of mold or mildew, dangerous loss of traction, etc. Wooden or composite material docks extending over bodies of water and exposed to the elements are particularly susceptible to environmental degradation.

Most waterfront homes and waterfront commercial venues have docks, piers or decks exposed to the environment. If made from wood, the wood is treated to increase resistance to the environmental degradation, typically by applying a waterproofing compound. It is also common to construct the docks, piers and decks from manufactured composite materials, often comprising cellular PVBC or wood composites encapsulated in polyethylene. When these materials degrade, they are typically repaired by removing the damaged material and replacing the material with new pieces.

Typical material used in docks, piers and decks is slippery when wet, degrades to form splinters, becomes uncomfortably hot from the sun, warps to expose nails or screws, presents uneven and rough surfaces, and is susceptible to mold, mildew, stains, bug infestation, etc. Painting the surfaces, providing adhesive-backed non-slip tapes, etc. are not satisfactory solutions to the problems.

It is an object of this invention to provide a surface covering member adapted for affixation to support surfaces and structural members that addresses the problem of environmental exposure and degradation by providing a composite laminate surface covering member for the support surfaces and structural members that is suitable for use in construction, retrofitting, repair and resurfacing, the surface covering member, among other benefits, providing a barrier against the environmental exposure and degradation, increasing traction, especially in wet conditions due to its internal channeled structure that rapidly drains liquid laterally from the surface of the member, and is particularly effective in marine environments.

### SUMMARY OF THE INVENTION

The invention is a composite laminate surface covering member in the form of a panel or mat that can be placed or affixed onto horizontal support surfaces or wrapped or otherwise affixed to structural members (collectively referred to hereinafter as substrates), preferably being mounted to the substrates with adhesives or mechanical fasteners. The surface covering member is a sheet-like mat comprising at least two layers—an upper layer of vibration oriented polymer granules adhesively bonded together at a density that allows the layer to be significantly porous to liquid and such that it presents a non-planar upper surface for enhanced traction, and a liquid impermeable sub-layer formed of a closed cell polymer foam that is adhered to the underside of the upper layer and which is non-porous. An adhesive layer may be provided on the underside of the sub-layer prior to bonding the sub-layer to the upper layer, the adhesive layer being temporarily covered by a release liner member that is removed when the surface covering member is to be affixed to a substrate.

A reinforcing mounting layer may be adhered to the closed cell polymer foam sub-layer to enhance the structural integrity of the surface covering member, such as for example a fiber reinforced or woven sheet member in the form of a fabric, woven fiberglass, mesh or felt, and to provide a better bonding mechanism for affixation of the surface covering member to the substrates, the mounting layer being porous to the mounting adhesive. An intermediary layer composed of a screen or mesh may be positioned between the bottom mounting layer and the foam sub-layer, the apertures of this intermediary layer being significantly greater than the apertures of the mounting layer. This intermediary layer provides receptacles to receive the bonding material, such as an epoxy, that is used to adhere the surface covering member to the substrate.

The upper bonded granular layer is formed by mixing the polymer granules and a polymeric adhesive to form a sludge, placing the sludge mixture onto a horizontal vibration bed between form members, preferably with the sub-layer already positioned within the form, screeding the mixture to get the proper height, then tamping and vibrating the mixture to properly orient and settle the particles to produce a mat of the desired thickness and density. This methodology results in an extensive network of voids and irregular channels within the upper layer, such that water and other liquids will readily move into and then laterally within the layer for rapid drainage to preclude surface pooling of the liquid. The composite laminate surface covering member so produced can be cut to any desired shape.

Alternatively, the invention is a multi-layer surface covering member affixable to a substrate, said member comprising an upper layer bonded to a sub-layer; said upper layer composed of adhesively bonded granules, the distribution of said granules defining voids and irregular channels between the granules, said upper layer being liquid permeable; and said sub-layer composed of a closed cell polymer material, said sub-layer being liquid impermeable. Even further, the invention is formed as a sheet, the thickness of the combined upper layer and sub-layer being significantly smaller than the lateral dimensions; wherein said granules of said upper layer are composed of polymeric material; wherein said polymeric material is chosen from the group of polymeric materials consisting of granulated thermoplastic vulcanizate (TPV), ethylene propylene diene monomer (EPDM), polyolefin material, and mixtures thereof; wherein said sub-layer is composed of a polymer foam; wherein said polymer foam is chosen from the group of polymer foams consisting of polyethylene or synthetic chloroprene rubber; further comprising an adhesive layer disposed on said sub-layer; further comprising a reinforcing mounting layer adhered to said sub-layer; wherein said reinforcing mounting layer is chosen from the group of reinforcing mounting members consisting of fiber mesh, carbon fiber reinforced polymer and fiberglass sheet; further comprising a reinforcing intermediate layer disposed between said upper layer and said sub-layer, such that said sub-layer is bonded to said upper layer through said reinforcing intermediate layer; wherein said reinforcing intermediate layer is chosen from the group of reinforcing mounting layers consisting of fiber mesh, carbon fiber reinforced polymer and fiberglass sheet; wherein said sub-layer is thinner than said upper layer; and/or wherein said member has an edge formed entirely of said upper layer granules.

Alternatively still, the invention is a multi-layer surface covering member affixable to a substrate, said member produced by the steps of providing a form on a vibration bed; positioning a liquid impermeable sub-layer composed of a closed cell polymer material within said form, said sub-layer being liquid impermeable; forming a sludge mixture of polymeric granules and a liquid adhesive, and pouring said sludge mixture onto said sub-layer within said form; screeding, tamping and vibrating said sludge mixture to a desired thickness and density such that voids and irregular channels are present between said granules; allowing said sludge mixture to cure, such that said upper layer is bonded to said sub-layer and said upper layer is liquid permeable, and further wherein said steps of producing said member further comprise adhering a reinforcing mounting layer to said sub-layer, and wherein said sub-layer is positioned within said form with said reinforcing mounting layer below said sub-layer; and/or wherein said steps of producing said member further comprise positioning a reinforcing intermediate layer on top of said sub-layer prior to pouring said sludge mixture, such that said sub-layer is boned to said upper layer through said intermediate layer.

### BRIEF DESCRIPTION OF THE DRAWINGS

FIG. 1 is a cross-sectional view of an embodiment of the multi-layer surface covering member having an upper bonded granular layer and a liquid impeiiiieable sub-layer.

FIG. 2 is a cross-sectional view of an embodiment of the surface covering member similar to FIG. 1 with an adhesive layer disposed on the liquid impermeable sub-layer.

FIG. 3 is a cross-sectional view of an embodiment of the surface covering member having a reinforcing intermediate layer disposed between the upper bonded granular layer and the liquid impermeable sub-layer.

FIG. 4 is a cross-sectional view of an embodiment of the surface covering member similar to FIG. 3 with an adhesive layer disposed on the liquid impermeable sub-layer.

FIG. 5 is a cross-sectional view of an embodiment of the surface covering member showing a reinforcing mounting layer disposed on the liquid impermeable sub-layer and also showing the upper bonded granular layer extending beyond the edges of the reinforcing mounting layer and the liquid impermeable sub-layer to form the entire edge of the laminate surface covering member.

### DETAILED DESCRIPTION OF THE INVENTION

Various embodiments of the invention shall now be described in detail with reference to the drawings, the drawings presenting non-limiting illustrations of embodiments of the invention. The drawings are not to scale.

The invention is a composite laminate, i.e., multi-layer, surface covering member in the form of a sheet, panel or mat (i.e., a thin member having a thickness dimension significantly smaller than its lateral dimensions) that is adapted to be placed onto horizontal support surfaces, such as for example the deck members of a marine dock, or wrapped or otherwise applied to horizontal or vertical structural members, such as for example marine post members. The surface covering member is preferably mounted to the support surfaces and structural members with adhesives or mechanical fasteners. The term “substrates” shall be used herein to collectively refer to the support surfaces and the structural members. The surface covering is particularly structured and suitable for use in marine environments, such as on docks, piers or decks, wherein the substrate is typically composed of wood or a manufactured composite decking material, due to the ability of the surface covering member to rapidly channel and drain water or other liquids.

The surface covering member is in the form of a sheet, panel or mat and comprises at least two layers. The first or upper layer 10 is composed of vibration oriented and settled polymer granules or particles adhesively bonded together at a density that results in an extensive network of voids defining irregular channels, such channel structures allowing the layer to be porous to liquid. The upper bonded granular layer 10 is further manufactured so as to present an upper surface having enhanced traction, the actual composition of the surface alternating between the upper portions of the uppermost granules and the voids or gaps existing between adjacent granules. The granules may be composed for example of granulated thermoplastic vulcanizate (TPV), ethylene propylene diene monomer (EPDM) or polyolefin material, mixtures thereof, or any granules possessing similar characteristics. The particles or granules are preferably between approximately 1 to 5 millimeters in size and irregularly shaped.

The second or sub-layer 11, which may form the bottom of the surface covering member or form an interior layer of the surface covering member, is composed of a closed cell polymer foam that is adhered to the underside of the upper layer 10. The sub-layer 11 is non-porous such that any liquid passing into the upper layer 10 is directly laterally by the liquid impermeable sub-layer 11 such that liquid, e.g., rain water, rapidly drains from the upper layer 10 without pooling on the surface, while liquid passage through the sub-layer 11 onto the substrate, such as a wooden board, is precluded by the non-porous foam sub-layer 11. The sub-layer 11 may be composed of a closed cell polyethylene or synthetic chloroprene rubber (e.g., Neoprene) material, or materials possessing similar properties. The closed cell foam provides enhanced water impermeability, durability, rebound and usage life in comparison to open cell foams or non-foam layer materials. The sub-layer 11 is preferably thinner than the upper layer 10.

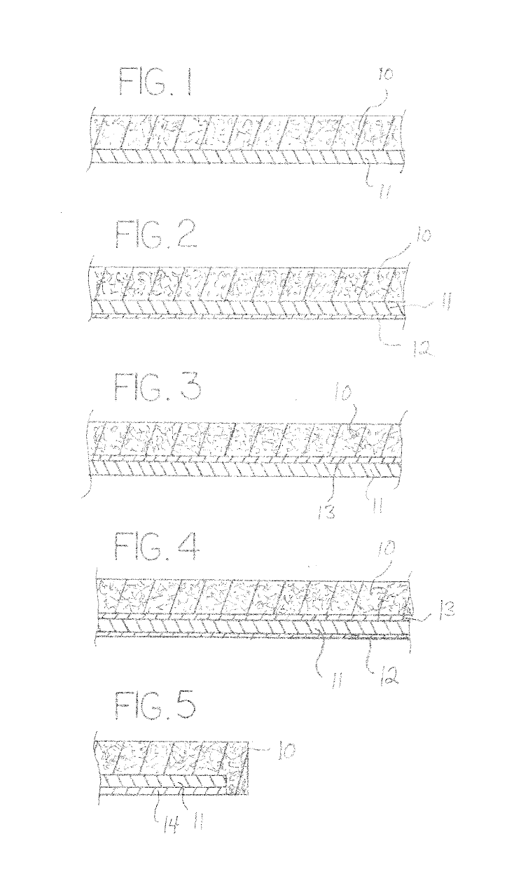

The surface covering member may consist of the upper layer 10 and sub-layer 11, as shown in FIG. 1, in which case the surface covering member is subsequently affixed to the substrate by application of an adhesive onto the substrate or the underside of the sub-layer just prior to installation. Alternatively, as shown in FIGS. 2 and 4, the sub-layer 11 may be provided with a mounting adhesive layer 12 prior to its being bonded to the upper layer 10, in which case the mounting adhesive layer 12 is covered by a removable release liner member (not shown), which is removed prior to installation of the surface covering member onto the substrate.

In an alternative embodiment, a third layer, being a structural reinforcing mounting layer 14, is bonded to the underside of the closed cell polymer foam sub-layer to enhance the structural integrity of the laminate surface covering member, such as for example a woven fiber or fiber reinforced material in the form of a fabric, cloth, felt, woven fiberglass or the like. The use of a fabric-type sheet material for the bottom layer also provides an optimal structure for adhesively bonding the surface covering member to the substrate, as the permeability and/or apertures in the bottom layer allow the bonding adhesive to penetrate and contact the closed cell polymer foam sub-layer 11. Suitable materials for the reinforcing mounting layer 14 include for example a fiber mesh, a carbon fiber reinforced polymer or fiberglass sheet. A 10×10 to 30×30 mesh may be utilized. This embodiment is illustrated in FIG. 5. This reinforcing mounting layer 14 may also consist of a laminate further comprising an additional reinforcing screen or mesh layer having large apertures relative to the apertures of the reinforcing mounting layer 14. This laminate structure provides a large number of reservoirs to receive a mounting adhesive, such as for example an epoxy, that is applied to the bottom reinforcing mounting layer 14 in order to install the surface covering member on a substrate.

In still another embodiment, shown in FIGS. 3 and 4, a reinforcing intermediate layer 13 is provided between the foam sub-layer 11 and the upper layer 10. The intermediate layer 13 may comprise for example a fiber mesh, a carbon fiber reinforced polymer or fiberglass sheet, preferably woven or formed with apertures of sufficient size to allow the adhesive bonding composition utilized in the upper layer 10 to bond the granules to flow through the reinforcing intermediate layer 13 to contact and bond the sub-layer 11.

In a preferred methodology, the surface covering member is produced by placing the sub-layer, adhesive side down if the sub-layer possesses a pre-applied adhesive 12 covered with a release liner, into a form having side walls, the form being disposed on or being part of a vibration bed. If a reinforcing mounting layer 14 is to be part of the surface covering member, it is placed into the form prior to the sub-layer 11, with suitable adhesive being applied so as to bond the mounting layer 14 to the sub-layer 11. The upper bonded granular layer 10 is formed by mixing the polymer granules and a polymeric adhesive or bonding agent, such as for example an aliphatic urethane, to form a sludge, which is then placed on top of the sub-layer 11 within the form on the horizontal vibration bed. The sludge mixture is then screeded to the desired thickness and then tamped and vibrated to properly orient and settle the particles to produce a mat of the desired thickness and density, the upper layer 10 retaining a significant number of voids and irregular channels. After curing, the surface covering member is removed from the form.

Alternatively, the upper bonded granular layer 10 may be independently formed and then joined to the closed cell polymer sub-layer 11 using an adhesive. The sub-layer l lmay be provided with minute perforations, such as by passing a spiked roller over the material to produce extended holes roughly 0.040 inches in diameter, which then draw the adhesive into the body of the foam sub-layer 11 to provide better adhesion to the upper bonded granular layer 10, the impermeability of the sub-layer 11 being maintained because the adhesive seals the perforations. If present, the reinforcing mounting layer 14 is then adhesively bonded to the exposed side of the foam sub-layer 11. The bottom reinforcing mounting layer 14 may be affixed with an adhesive sprayed, brushed, rolled or otherwise applied to the surfaces of the layers. The adhesive used to join the reinforcing mounting layer 14 and foam sub-layer 11 is chosen so as not to block the apertures in the reinforcing mounting layer and the intermediate layer.

To secure the surface covering member to the substrate when the release liner covered adhesive layer 12 is not present, the surface covering member is inverted and a liquid adhesive or bonding composition, such as an epoxy for example, is applied onto the lowermost layer. If the laminate reinforcing mounting layer 14 is utilized, the substrate bonding composition flows through both layers of the reinforcing mounting layer 14 and further adheres the sub-layer 11. Any excess bonding composition is then removed. When the surface covering is inverted and placed onto the substrate, some of the bonding composition retained within the receptacles of the laminate reinforcing mounting layer 14 layer flows down through the bottom reinforcing layer 14 and onto the substrate, thereby fully saturating the reinforcing mounting layer 14 and insuring that the necessary amount of substrate bonding adhesive is present to affix the surface covering member to the substrate. With this structure and methodology, the substrate bonding adhesive composition extends from the foam sub-layer 11, through the laminate reinforcing mounting layer 14 to the substrate itself, creating a secure and long-lasting adhesion.

In a preferred embodiment, as shown in FIG. 5, the edge or perimeter of the surface covering laminate is formed by the upper layer vibration oriented polymer granules or particles. This is accomplished by using a sub-layer 11 and any additional layers having slightly smaller lateral dimensions than the upper layer 11, such that on the edges of the form the granular sludge will extend down to the bottom of the form. This construction improves the aesthetics of the surface covering sheet by hiding the other layers and enhances the lateral draining efficiency.

The composite laminate surface covering member so produced can be cut to any desired shape as required for installation, and may be cut to produce designs, patterns, images or words. Additional members may be embedded into the surface covering, either within the upper layer or between layers, such as flexible cooling tubes, flexible light tubing, cordage for ease of handling during manufacture, decorative elements, etc. A typical surface covering member may be 0.125 to 3 inches in thickness, for example. The perimeter edges may extend from 0.10 to 3 inches into the interior, for example. The upper layer granules may vary in color and be intermixed or segregated to form designs, patterns, images or words during manufacture.

Because the polymer granules of the upper layer 10 do not form a surface having a solid, continuous, planar upper surface, there being gaps and channels between adjacent particles, the upper bonded granular layer 10 possesses good non-slip properties. The high traction surface covering as described possesses a wet dynamic coefficient of friction (DCOF) in excess of approximately 0.94, which greatly exceeds the American Disabilities Act and Occupational Safety and Health standards. Composite decking has a wet DCOF of approximately 0.45 and treated wood has a wet DCOF of approximately 0.64. The surface covering is significantly cooler than comparative materials, has greater impact attenuation, good anti-static properties, high UV resistance, high resistance to mold, mildew, fungus and insect propagation, high chemical resistance, high resistance to weathering, wet/dry cycling, chipping, cracking and splintering. Characterization testing shows the surface covering to be 5 times more slip resistant than composite decking (static and dynamic/wet and dry), three times more slip resistant than treated wood decking (static and dynamic/wet and dry) and three times greater in fall attenuation than wood or composite decking. The surface of the surface covering stays 24% cooler than composite decking in direct sunlight, 20% cooler than wood decking and 32% cooler than painted wood decking. When carbon fiber or woven roving is used as the reinforcing layer the structural integrity to live load of existing deck materials is improved by as much as 80%.

The composite laminate surface covering member may be provided with additional surface coatings to improve the characteristics listed above, such as by applying a super-hydrophobic or oleo-phobic coating to prevent staining or improve water channeling.

It is understood that equivalents and substitutions for elements and structures set forth above may be obvious to those skilled in the art, and therefore the true scope and definition of the invention is to be as set forth in the following claims.

I claim:

1. A multi-layer surface covering member affixable to a substrate, said member comprising an upper layer bonded to a sub-layer;
said upper layer composed of adhesively bonded granules, the distribution of said granules defining voids and irregular channels between the granules, said upper layer being liquid permeable; and
said sub-layer composed of a closed cell polymer material, said sub-layer being liquid impermeable.

2. The member of claim 1 formed as a sheet, the thickness of the combined upper layer and sub-layer being significantly smaller than the lateral dimensions.

3. The member of claim 1, wherein said granules of said upper layer are composed of polymeric material.

4. The member of claim 3, wherein said polymeric material is chosen from the group of polymeric materials consisting of granulated thermoplastic vulcanizate (TPV), ethylene propylene diene monomer (EPDM), polyolefin material, and mixtures thereof.

5. The member of claim 1, wherein said sub-layer is composed of a polymer foam.

6. The member of claim 5, wherein said polymer foam is chosen from the group of polymer foams consisting of polyethylene or synthetic chloroprene rubber.

7. The member of claim 3, wherein said sub-layer is composed of a polymer foam.

8. The member of claim 4, wherein said polymer foam is chosen from the group of polymer foams consisting of polyethylene or synthetic chloroprene rubber.

9. The member of claim 1, further comprising an adhesive layer disposed on said sub-layer.

10. The member of claim 1, further comprising a reinforcing mounting layer adhered to said sub-layer.

11. The member of claim 10, wherein said reinforcing mounting layer is chosen from the group of reinforcing mounting members consisting of fiber mesh, carbon fiber reinforced polymer and fiberglass sheet.

12. The member of claim 1, further comprising a reinforcing intermediate layer disposed between said upper layer and said sub-layer, such that said sub-layer is bonded to said upper layer through said reinforcing intermediate layer.

13. The member of claim 12, wherein said reinforcing inteimediate layer is chosen from the group of reinforcing mounting layers consisting of fiber mesh, carbon fiber reinforced polymer and fiberglass sheet.

14. The member of claim 1, wherein said sub-layer is thinner than said upper layer.

15. The member of claim 1, wherein said member has an edge formed entirely of said upper layer granules.

16. A multi-layer surface covering member affixable to a substrate, said member produced by the steps of:
providing a form on a vibration bed;
positioning a liquid impermeable sub-layer composed of a closed cell polymer material within said form, said sub-layer being liquid impermeable;
forming a sludge mixture of polymeric granules and a liquid adhesive, and pouring said sludge mixture onto said sub-layer within said form;
screeding, tamping and vibrating said sludge mixture to a desired thickness and density such that voids and irregular channels are present between said granules;
allowing said sludge mixture to cure, such that said upper layer is bonded to said sub-layer and said upper layer is liquid permeable.

17. The member of claim 16, wherein said steps of producing said member further comprise adhering a reinforcing mounting layer to said sub-layer, and wherein said sub-layer is positioned within said form with said reinforcing mounting layer below said sub-layer.

18. The member of claim 16, wherein said steps of producing said member further comprise positioning a reinforcing intermediate layer on top of said sub-layer prior to pouring said sludge mixture, such that said sub-layer is boned to said upper layer through said intermediate layer.
